(19) United States
(12) Patent Application Publication
(10) Pub. No.: US 2016/0131170 A1
(43) Pub. Date: May 12, 2016

(54) SCREW DRIVE

(71) Applicant: EJOT GMBH & CO. KG, Bad Berleburg (DE)

(72) Inventor: Nils LANDSMANN, Langewiese (DE)

(21) Appl. No.: 14/895,957

(22) PCT Filed: Jun. 5, 2014
(86) PCT No.: PCT/EP2014/061713

§ 371 Date: Dec. 4, 2015

(30) Foreign Application Priority Data
Jun. 5, 2013 (DE) 10 2013 105 812.4

(51) Int. Cl. F16B 23/00; B25B 15/00

(52) U.S. Cl. CPC F16B 23/003; B25B 15/004

(57) ABSTRACT

The invention relates to a screw with a screw head having a drive, and a corresponding drive tool, and a drive system having the screw and the drive tool. The screw embodies a screw head having a drive; the drive includes cams formed by recesses introduced in the screw head around the cams. Each cam has two side faces which are used to transmit torque, and an end face connecting the side faces. The end face has a concave surface contour on the end of the screw head facing away from the screw shank. The end face has a virtual circular periphery around the screw axis in a plane perpendicular thereto and having a radius associated with the plane has a point of contact on the cam with the end face. Over at least one portion of the axial height of the end face, a plurality of points of contact form a contact line in the centre of the end face. The drive tool incorporates a basic body having integral entraining elements in a radial extension to the outside. The basic body in which the tip for driving the screw is introduced, forms a conical portion which tapers toward the tip.

The invention relates to a screw with a screw head having a drive as specified in the preamble of claim 1, and a corresponding drive tool as claimed in claim 9, as well as a drive system comprising a screw and a drive tool as claimed in claim 18.

Screws of the type disclosed in German patent document DE 199 23 855, for example, have a screw head including a drive. The design of this drive normally has recesses formed in the screw head which are shaped so as to form cams in the edge region, which cams have side faces for transmitting a rotary movement. The recesses extend between the cams in such a way that a tool can be applied to them, which tool will then entrain the screw as it turns. A generic screw of this type, as well as a mating drive tool of a cylindrical basic design, is also disclosed in U.S. Pat. No. 5,279,190.

Previously known screw drives have the disadvantage that—while the design of their cams usually ensures good transfer of the rotary movement and provides high wear resistance—the screw will not adhere to the entraining tool even temporarily.

To overcome this problem, it is known to use a magnetized tool to assure some degree of loss prevention during the screwing process. However, this retaining solution will not work for non-ferromagnetic screws.

U.S. Pat. document no. 2009/0,260,489 discloses a screw drive having cams that approach each other in the direction of the screw shank. The cams are shaped as convex forms, and are driven using a tool of a mating design.

Apparently, clamping the screw in place on the tool can only be assured, as in German patent document no. DE 10 2004 022 852 DE A1, by means of a special tool having a core that tapers towards the tip of the tool and has planar regions on its circumferential surface.

Disclosed in European patent no. EP 0 524 617 B1 is a drive having cams for driving the screw, said cams being formed by introducing recesses into the screw head around the cams. The cams have lateral areas for torque absorption which are connected by an end face. The head-side end of this end face facing away from the screw shank has a concave surface contour so as to facilitate introduction of a screw-driving tool into the drive.

A common approach to improving the corrosion resistance of screws, in particular screws for use in thermally treated components, is to coat the screws in a dip, spin or spray coating process. Examples are zinc flake systems, sealings etc. In view of their viscosity and adhesion tendency, these coating processes tend to produce layer accumulations of varying thicknesses on concave forms, in particular concave surfaces or radii.

Current state-of-the-art screw drives and threads will become blocked locally by layer accumulations of up to 200 μm, for which reason, they cannot fully accomplish their function and/or conform to their specifications anymore. To prevent any impairment of the screw-driving process due to such layer accumulations, such prior art surfaces are not used for small or miniature screws. A zinc flake coating, for example, is usually only applied in several layers on screws having a minimum nominal diameter of 6 mm.

It is the object of the invention to provide a screw, notably a small or miniature screw, whose drive has been designed to further facilitate its handling and which can be held in place at least temporarily on a mating drive tool of simple design through mechanical clamping.

This object is accomplished for the screw by the characterizing features of claim 1 in combination with the features specified in its preamble.

The subclaims define advantageous further developments of the invention.

A prior art screw head has cams which are formed by recesses provided in the screw head around the cams. Each cam has two side faces which serve to transfer torque, and an end face connecting the side faces. The portion of the end face facing away from the screw shank—the contact region—has a substantially concave surface contour.

According to the present invention, the end face is furthermore designed such that a virtual circular periphery around the screw axis in a plane perpendicular thereto and having a radius associated with the plane has a point of contact on each cam with the end face, with a plurality of such points of contacts being formed over at least one portion of the axial height of the end face—the contact region—said points of contacts forming a contact line in the centre of the end face.

When a mating tool having a basic body of a circular cross-section is used, this design ensures that the tool, when introduced into the end face, will only make linear contact therewith. In this case, the radial distance between the cam end faces and the screw axis shall be defined here as the so-called B dimension, and the circumference radially abutting externally on the cam side faces shall be defined here as the so-called A dimension.

It is essential to the invention that the clamping effect obtained by the contact line on the cam end face is provided for in the B dimension. This is advantageous in that it allows the A dimension to be chosen as desired to meet torque transmission or other requirements without diminishing the clamping effect in any way. The clamping effect according to the invention has proven particularly advantageous for miniature screws whose handling is considerably facilitated by the screw being clamped in place on the drive tool.

The linear contact surface may be designed such that its concave surface exhibits a curvature whose radius is larger in one plane than the radius of the virtual circle of this plane. According to the invention, such concave contour may be circular or elliptical but can also be approximated to such a shape by line elements, with the curvature being smaller than that of the associated virtual circular periphery.

Preferably, the end face is designed such that the radius of the virtual circular periphery will continuously decrease towards the screw shank in one portion of the axial height direction. Consequently, the contact line will be inclined with respect to the screw axis. Such a conical extension of the contact line has the advantage that the adhesive effect of the screw can be considerably increased when a mating tool is used which has the same inclination.

This is the case in particular when the contact line is inclined at an angle of less than 10° with respect to the screw axis. In this way, an improved press fit will be obtained when using a screw-driving tool having a frusto-conical basic body.

A contact line extending at an angle with respect to the screw axis will preferably be obtained by providing a convex contour on the end of the side face facing the screw shank. As a result, particularly the vertical projection of the line connecting the points in which the convex and concave contours overlap will extend in parallel to the screw axis at the ends of the side faces.

This allows the angle of the contact line to be set via the radii of the convex and concave contours. Providing a convex contour on the end of the screw drive facing the screw shank will facilitate the removal of any coating material applied to the screw in a coating process from the screw drive cavities. This thus prevents coating material layers from accumulating in the B dimension which would interfere with the handling of the screw. This holds true especially for screw drives of small and miniature screws.

The transition from concave to convex structures may preferably be a freeform surface. This is a particularly robust way of achieving linear contact on the side face since it yields a largely planar design which will still allow linear contact of a screw-driving tool of circular cross-section in the B dimension. Since the planar design avoids further cavities, this will also be advantageous with regard to the removal of any excessive coating material.

Preferably, the screw drive has precisely three cams which each have a point of contact on the cam side face in an associated plane and form a contact line via their end faces. Providing precisely three cams will ensure ideal centering of the tool and thus optimized traction between the cams and the basic body of an introduced screw-driving tool, in order to retain the screw on the screw-driving tool.

Using exactly three cams serves to achieve a stick-fit effect. If precisely three such cams are used which preferably form an innermost B dimension, this basically also allows the presence of additional cams purely for torque transmission. The radially innermost point of such additional cams will be spaced further from the screw axis than the radius of the virtual circle associated with the plane.

This will facilitate handling of the screw as well as improve torque transmission. Furthermore, this will yield some freedom in designing the entraining elements of the entraining tool for torque transmission in the A dimension.

In the A dimension of the screw drive, the drive is notably cylindrical.

According to the present invention, the radial extension of the cams is thus arranged and designed so as to centre a tool introduced into the screw drive, and furthermore, the head surface is subdivided into first and second surfaces, each of which is inclined in a respective direction of rotation.

The fact that the head surface is subdivided into two surfaces allows the screw to be swiftly placed on a drive tool in any direction of rotation. Such a design is particularly advantageous for small and miniature screws since their handling, in particular placing them on a drive tool, is already difficult anyhow.

Preferably, the surfaces are disposed such that the two surfaces intersect each other in an intersection line in the centre of the cam.

This ensures that a minimal rotary movement of the screw will suffice to optimally introduce the drive tool into the screw. Also, a screw of this type with a symmetrical design of the head surface has proven to be considerably easier to manufacture.

In another advantageous embodiment of the invention, the intersection line is inclined toward the centre of the screw with respect to the plane that is perpendicular to the screw axis. Consequently, the recesses of the cams not only facilitate the introduction of entraining elements of a drive tool in a circumferential direction, but also urge them into proper alignment in a radial direction. Preferably, an inclination of the intersection line of between approx. 10° and 30° may be chosen with respect to the plane which is perpendicular to the screw axis.

According to the invention, both surfaces of the head surface define an obtuse angle, in particular of between 120° and 160°, at their intersection line. Since, starting from the end facing the screw head, the inclination of the head surface reduces the cam side faces which effectively transfer torque, an ideal setting is thus obtained for these inclination angles as far as effective tool introduction and transfer of torque are concerned.

Preferably, the intersection line of the first and second surfaces is rounded. This rounding of the intersection line facilitates control of the drive tool since it prevents the drive tool from getting jammed on the cutting edge.

In yet another advantageous embodiment of the invention, the angle defined between the two side faces of a cam is smaller than the angle defined between two side faces of two adjacent cams. This is particularly advantageous for the production of miniature screws since the recesses around the cams which are enlarged relative to the cams will ensure improved discharge of coating material.

In yet another aspect of the invention, the invention relates to a drive tool. A corresponding drive tool of the prior art has a tool shank on which entraining elements are formed in its radial extension, which elements are used to transfer torque to the side faces of cams of a screw. The tip portion of this drive tool has an engaging section which is used to engage the drive of a screw in an axial extension thereof.

According to the present invention, the shank of the drive tool, at least the engaging section thereof, conically tapers in a frusto-conical shape in the direction of engagement, whereas the outer portion of the entraining elements extends cylindrically. This basic shank design results in a basic shape which can be easily manufactured and which will produce a clamping effect when used with a screw having a drive of the aforementioned type. The cylindrical shape of its external dimension also ensures maximum contact surface for transferring torque to the screw.

The inclination of the lateral area of the cone in particular extends at an angle of more than 0° and up to approx. 10°. A design of this type will yield an ideal clamping effect with the screw drive.

In yet another embodiment of the invention, the entraining elements extending radially from the tool shank are designed such that each entraining element has two side faces, with the angle defined between the two side faces being larger relative to the screw axis than the angle defined between two side faces of adjacent entraining elements. In particular, the ratio of the entraining element angle and the distance angle is approx. three to four. Such a ratio is also considered advantageous for a mating screw drive.

In particular for the production of tools for miniature screws, this asymmetrical distribution of entraining angle and distance angle will have the advantage that the design of the entraining elements can be made sufficiently robust despite their basically small dimensions.

The A dimension of the drive tool, with a suitable B dimension, will be smaller than the A dimension of a mating drive of a screw. As a result, drive tool and screw will engage each other with some clearance in the A dimension.

In a further development of the invention, a cylindrical outer form of the entraining elements whose cross-section resembles the segment of a circle, has rounded corners in the transition between side face and outer surface. The rounding of these edges preferably has a radius of less than half of the radial extension of the side face. The side faces have been chosen such that for a screw of mating design, a contact surface will be obtained on the side face of a cam. The radial extension of the side face has been chosen such that force will be applied over a large area and that stripping of the cam will be prevented when the minimum fracture torque of the screw is applied. A design of this type will effectively prevent overstripping, in particular for a small number of entraining elements.

Preferably, precisely three entraining elements are provided on the drive tool. Providing precisely three entraining elements on the tool will ensure largely uniform distribution of torque to all cams despite the existing tolerances.

Preferably, the drive tool is elliptically rounded, with the curvature of the rounded portion on the entraining element being smaller than the curvature of the corresponding transition area on the drive of a screw having a suitable B dimension. A suitable B dimension has been achieved if, in one plane, the B dimension of the screw roughly corresponds to the B dimension of the drive tool in its fully introduced position.

While the present invention cannot eliminate the physical properties of a coating material, any effects which will interfere with its application will be largely considered in its constructive design. In the drive tool of the invention, spaces are provided in the corresponding radii for any layer accumulations as a result of surface tensions, as far as this is technically feasible in its design. This will allow introduction and proper functioning of the drive tool even when thick layers have formed at the bottom of the drive and in the transitional areas between the A dimension and the side faces of the cam.

Additional advantages, features and possible applications of the present invention may be gathered from the description which follows, in which reference is made to the embodiments illustrated in the drawings.

Throughout the description, claims and drawings, the same associated reference signs are used. In the drawings,

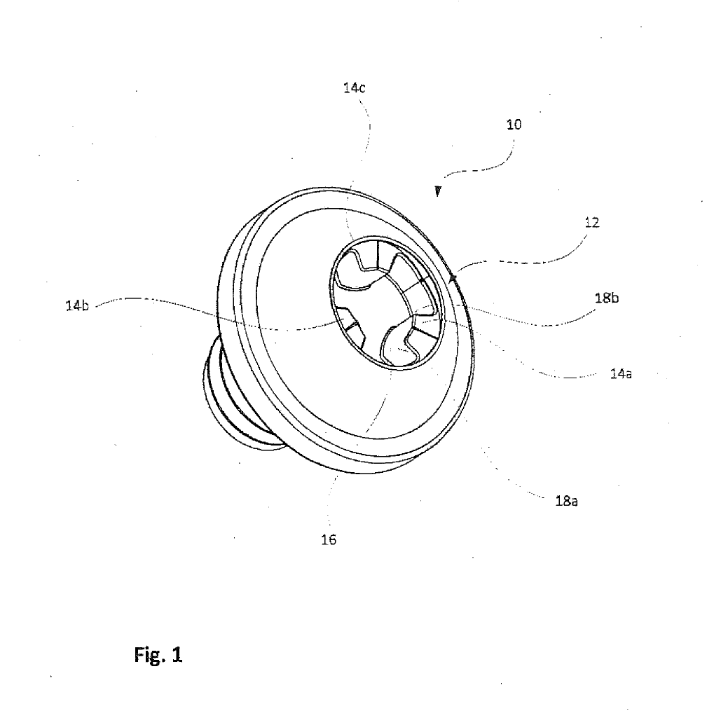

FIG. 1 is a view of a screw of the invention having a screw head with a drive;

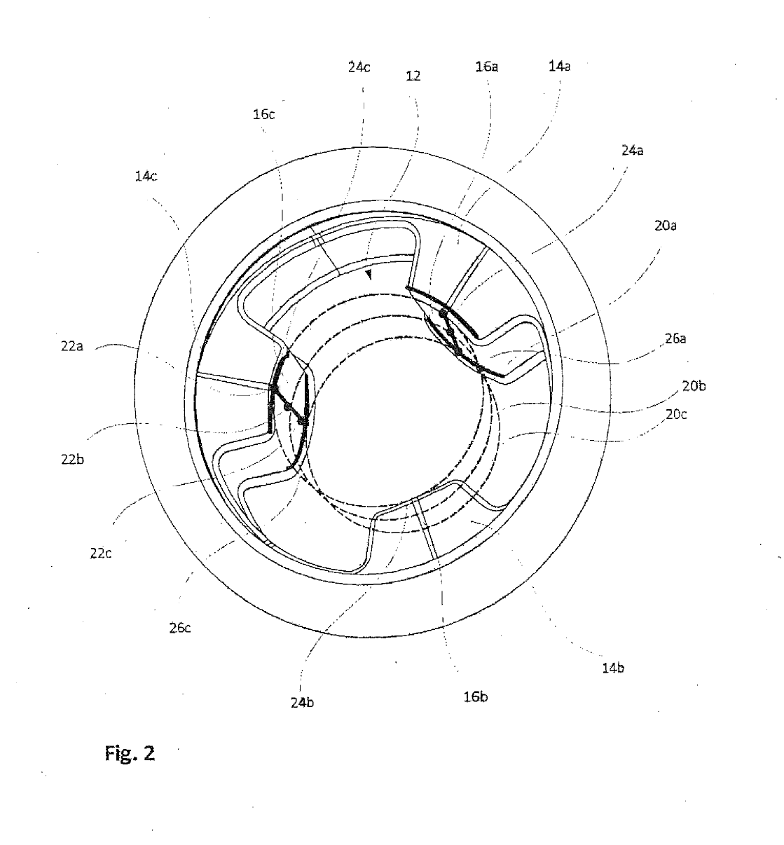

FIG. 2 is a perspective view of a screw drive according to the invention which has three cams;

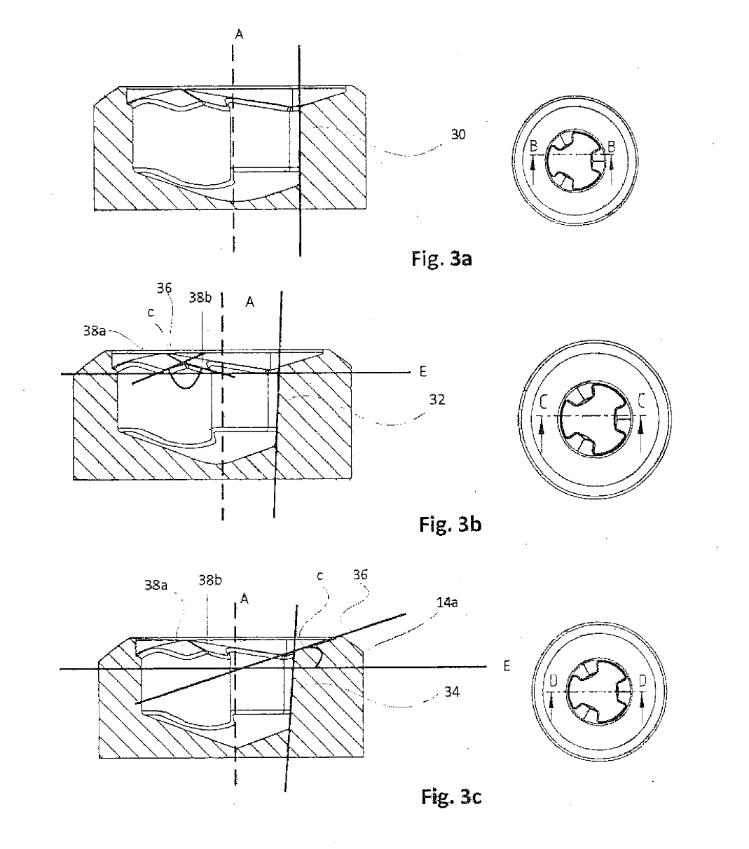

FIG. 3a is a view of a section taken along lines B-B;

FIG. 3b is a view of a section taken along lines C-C;

FIG. 3c is a view of a section taken along lines D-D;

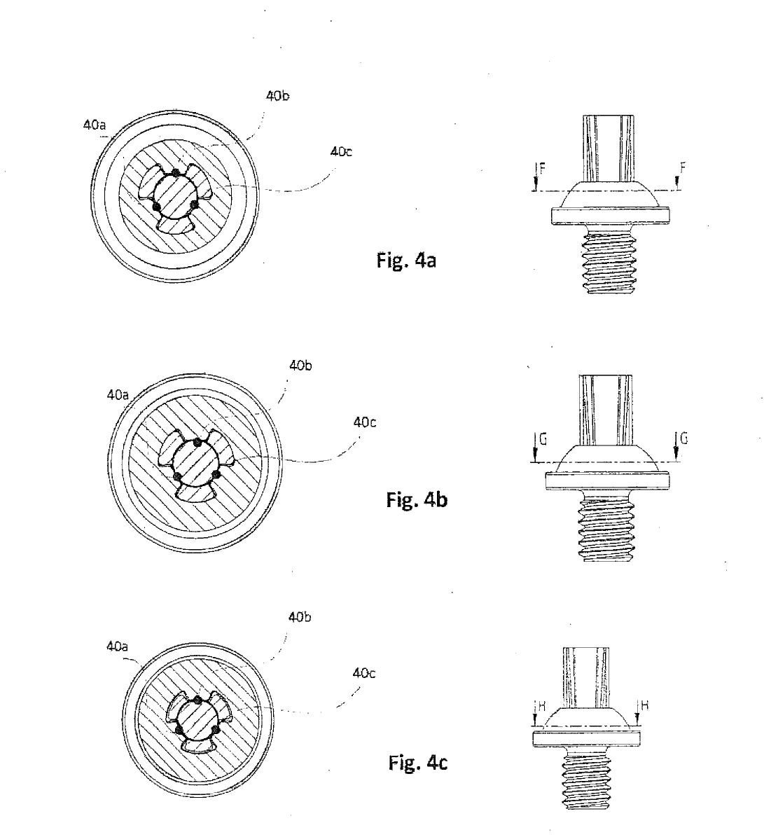

FIG. 4a is a view of sections of the screw with a drive tool introduced therein;

FIG. 4b is a view of sections of the screw with a drive tool introduced therein;

FIG. 4c is a view of sections of the screw with a drive tool introduced therein;

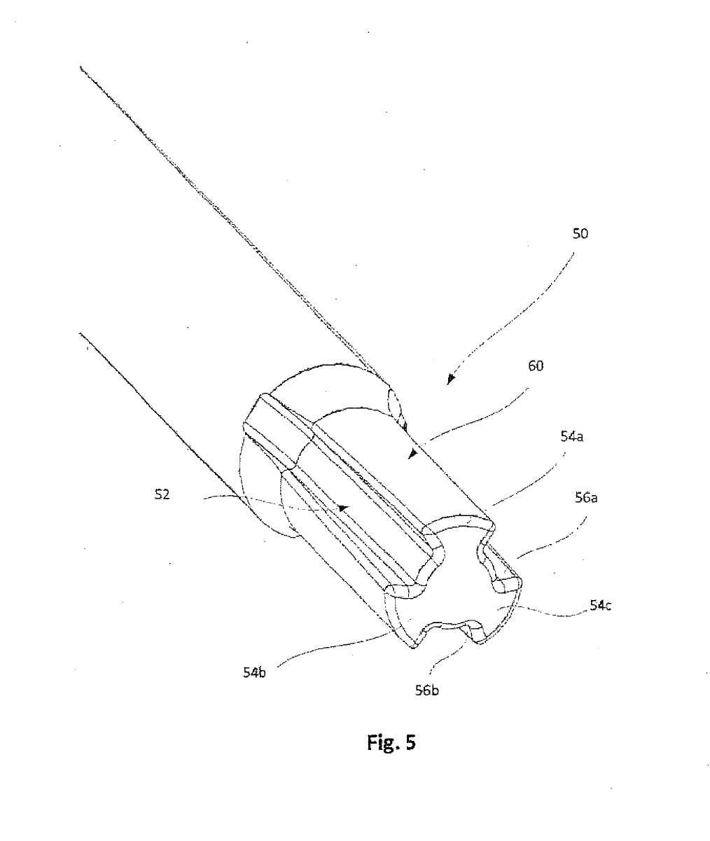

FIG. 5 is a perspective view of a drive tool;

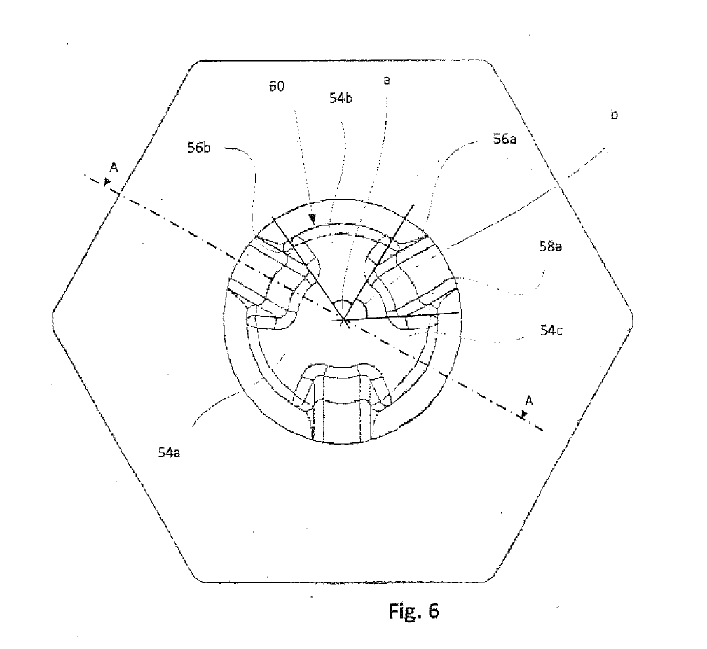

FIG. 6 is a top view of a drive tool, and

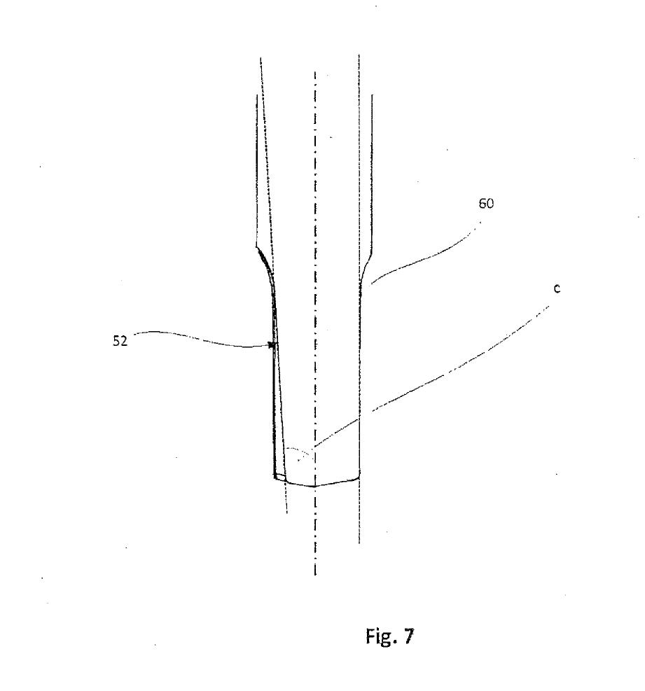

FIG. 7 is a view of a section taken along lines A-A.

As seen in FIG. 1, the screw 10 of the invention has a screw head with a drive 12. The drive 12 of the screw comprises cams 14a, 14b, 14c which act to transfer torque. Cams 14a, 14b, 14c are formed by recesses made in the screw head around the intended cams 14a, 14b, 14c. Cams 14a, 14b, 14c have side faces 18a, 18b as well as an end face 16 which connects the two side faces 18a, 18b. Torque is transmitted in a tangential direction to the side faces 18a, 18b by a corresponding tool. The essential features of drive 12 will be explained in more detail below with reference to FIG. 2.

FIG. 2 is a perspective view of drive 12 according to the invention which has three cams 14a, 14b, 14c. According to the present invention, the end faces 16a, 16b, 16c are designed such that their ends facing away from the screw head have an essentially concave surface contour. According to the invention, the end faces 16a, 16b, 16c are designed such that they have exactly one point of contact with a virtual circular periphery 20a, 20b, 20c which extends in a plane perpendicular to the screw axis.

Furthermore, the end face 16 is designed such that these points of contact 22a, 22b, 22c will be a plurality of contact points 22a, 22b, 22c over at least one portion of the axial height of the end face. According to the inventive design of the end face 16, these points of contact will form a contact line 24a, 24b, 24c in the centre of the end face 16 of cams 14a, 14b, 14c. When a drive tool (not shown) is used whose basic body is circular in cross-section, such design will cause the drive tool to rest against the contact lines 24a, 24b, 24c. The fact that the basic body of the drive tool only makes contact with the screw 10 in these three lines allows a sufficiently high radial pressing force to be applied which will cause the screw 10 to be securely held on a drive tool in these contact lines 24a, 24b, 24c. As can further be seen in FIG. 2, the cams feature a convex contour 26a, 26c at the bottom of the screw drive. The transition from a convex to a concave contour is a freeform surface. This freeform surface is expediently designed such that the contact lines 24a, 24b, 24c will be obtained by way of the contact region. The design of the end face will be described in more detail with reference to FIGS. 3 and 4 which follow below.

The view of FIG. 3a is a longitudinal section through the screw head taken along lines B-B, which section extends through the area in which the convex and the concave surface contours overlap in their perpendicular projection. As can be seen in FIG. 3a, the line 30 connecting the concave and convex contours extends in parallel to screw axis A at this point.

The view of FIG. 3b is a longitudinal section through the screw head taken along lines C-C, between the transition area from the side face to the end face 16 and the centre of the end face 16. In this area, the line 32 connecting the concave contour in the upper region of the contact line and the convex contour at the bottom of the drive is already slightly inclined with respect to screw axis A.

As can furthermore be seen in FIG. 3b, the two surfaces 38a, 38b which intersect each other in one intersection line 36, are each inclined in a direction of rotation with respect to plane E which is perpendicular to the screw axis. The intersection line of the two inclined surfaces 38a, 38b is in the centre of cam 14b. This will thus ensure that, depending on the position of entraining elements of a drive tool to be introduced, screw 10 will only have to perform a minimal turn in order to position the entraining elements in the recesses provided so as to make contact with the cams 14b. In this case, the two surfaces 38a, 38b will define an angle c of approx. 150° between them. This angle c has been chosen so as to facilitate introduction of the drive tool and enable the required sliding of the entraining elements down-ward along the cam head surface 30 and still leave a maximum side face 18a, 18b of the cam for the required torque to be transmitted without any problems. This solution is also ideal for miniature screws whose handling is difficult enough anyhow, since it allows them to be securely placed on a drive tool in a simple manner.

FIG. 3c is a longitudinal sectional view of the screw head taken along lines D-D which section extends through the centre of the cam end face 16 and thus shows the contact line. The contact line is the radially innermost portion of the cam which also has the maximum inclination of the end face with respect to screw axis A. In the present design, this inclination is approx. 4°. The inclination is a result of the horizontal offset of the concave and convex contours in the centre of the cam end face and the height of the penetration depth of the screw drive and/or the height of the contact line.

As can further be seen from this illustration, the intersection line 36 of surfaces 38a and 38b is inclined in a radial direction at an angle c with respect to a plane E which is perpendicular to the screw axis. This inclination c facilitates the introduction of a tool in a radial direction since it forces the tool to radially slide into the central centering region between the cams. Consequently, when a tool (not shown) is introduced, such tool will automatically be guided toward the centre of the screw.

FIG. 4a to 4c are cross-sectional views of the screw with the drive tool already introduced therein, which tool is circular in cross-section. As can be seen from these views, the end faces of the cams in the individual planes have points of contact 40a, 40b, 40c each with the drive tool of circular cross-section. The inventive design of the screw thus achieves a certain press-fit of a drive tool on the cams, which tool can be manufactured relatively easily and preferably has a frusto-conical basic body.

Torque is transferred via the side faces 18a, 18b of cams 14a, 14b, 14c. Mechanically clamping the drive tool to the screw makes for considerably improved handling of screws during processing.

In contrast to magnetic measures, such a loss protection can also be obtained with stainless steel or non-ferromagnetic materials. The sectional views clearly show the transition of the end face from its concave form in the upper region of the contact line, as seen in FIG. 4a, to a convex contour at the bottom of the drive, as seen in FIG. 4c.

As shown in the drawings, there will always only be one point of contact of the basic body of the drive tool with the end face of a cam in all planes of the contact region. The virtual circular periphery shown continuously decreases in radius from FIG. 4a to FIG. 4c.

FIG. 5 is a view of a drive tool 50 having a tool shank 52 with integral entraining elements 54a, 54b, 54c formed thereon. As explained in more detail with reference to FIG. 6, the design of the entraining elements 54a, 54b, 54c resembles a circular segment. In circular cross-section, the external surfaces 60 of the entraining elements 54a, 54b, 54c extend cylindrically over the entire external area. The tool shank, by contrast, has a frusto-conical shape which tapers toward the tip of the drive tool 50. The entraining elements 14a, 14b, 14c have side faces 56a and 56b which ensure that force will be applied over a large area to a corresponding cam side surface. This is a simple design which, when used with a screw of the type described with reference to FIG. 1 to 4, will still securely clamp a screw in place on the tool shank, owing to the pressure force applied to a linear contact surface on the cam end face.

FIG. 6 is a top view of a drive tool according to the invention. This top view shows the essentially cylindrical circular-segment-like arrangement of the entraining elements 54a, 54b, 54c. The entraining elements 54a, 54b, 54c define an entraining element angle a between side faces 56a and 56b. A distance angle b is defined with respect to side face 58a of an adjacent entraining element 54c. According to the invention, entraining element angle a is to be larger than distance angle b. As a result, for a drive tool made for miniature screws, the entraining elements 54a, 54b, 54c can thus be made sufficiently robust, for example. Furthermore, it is shown in FIG. 6 that the entraining elements 54a, 54b, 54c exhibit a curvature in their transition area from side face 56a to their outer region 60. This curvature has been chosen to be larger than the respective curvature of the mating screw drive. Consequently, it will be able to accommodate any coating material accumulating in the screw drive.

FIG. 7 is a sectional view taken along lines A-A which shows particularly clearly that the frusto-conical tool shank is inclined at an angle of 4° relative to the tool axis, whereas its outer surface extends in parallel to the screw axis.

1. A screw with a screw head having a drive, wherein the drive comprises:
cams formed by recesses introduced in the screw head around the cams, wherein each cam has two side faces which are used to transmit torque, and an end face connecting the side faces, said end face having a concave surface contour on the end of the screw head facing away from the screw shank characterized in that the end face is designed such that a virtual circular periphery around the screw axis in a plane perpendicular to the screw axis and having a radius associated with the plane has a point of contact on the cam with the end face, wherein—over at least one portion of the axial height of the end face—the contact region—a plurality of such points of contact are formed, said points of contact forming a contact line in the centre of the end face.

2. A screw as claimed in claim 1 characterized in that—at least in the contact region—the radius of the curvature of the concave surface contour is larger than the radius of the virtual circular periphery associated with the plane.

3. A screw as claimed in claim 1 characterized in that the end face is designed such that the radius of the virtual circular periphery in the portion of the axial height will continuously decrease in the direction of the screw shank, with the contact line, extending at an angle to the screw axis.

4. A screw as claimed in claim 1 characterized in that the contact line is inclined at an angle of less than 10° with respect to the screw axis so as to produce a surface pressure when a circular symmetrical tool is being introduced.

5. A screw as claimed in claim 1 characterized in that the end of the screw head facing the screw shank has a convex surface contour.

6. A screw as claimed in claim 5 characterized in that the transition from the convex to the concave contour is a freeform surface.

7. A screw as claimed in claim 5 characterized in that the transition from end to side faces where the concave and convex contours intersect, extends in parallel to the screw axis.

8. A screw as claimed in claim 1 characterized in that three cams are provided which each have a point of contact on a side face of the cams in an associated plane.

9. A drive tool for introducing a screw with a screw head having a drive, wherein the drive comprises cams formed by recesses introduced in the screw head around the cams, wherein each cam has two side faces which are used to transmit torque, and an end face connecting the side faces, said end face having a concave surface contour on the end of the screw head facing away from the screw shank characterized in that the end face is designed such that a virtual circular periphery around the screw axis in a plane perpendicular to the screw axis and having a radius associated with the plane has a point of contact on the cam with the end face, wherein—over at least one portion of the axial height of the end face—the contact region—a plurality of such points of contact are formed, said points of contact forming a contact line in the centre of the end face,
wherein a drive tool comprises a basic body which has integral entraining elements formed thereon in a radial extension from the basic body to the outside characterized in that the basic body, at least in an engaging region thereof, in which the tip for driving a screw is introduced into the screw, forms a conical portion which tapers toward the tip.

10. A drive tool as claimed in claim 9 characterized in that the lateral surface of the cone is inclined at an angle of between 0° and approx. 10° with respect to the screw axis.

11. A drive tool as claimed in claim 9 characterized in that the entraining elements are of a circular segment-like design.

12. A drive tool as claimed in claim 11 characterized in that the entraining elements have side surfaces which define an entraining element angle with respect to the screw axis which angle is larger than the angle—distance angle—between two adjacent side surfaces.

13. A drive tool as claimed in claim 9 characterized in that the outer dimension of the entraining elements extends in a cylindrical basic form.

14. A drive tool as claimed in claim 9 characterized in that precisely three entraining elements are provided.

15. A drive tool as claimed in claim 11 characterized in that the entraining elements are of a rounded design in the transition area from the side surface to the outer surface.

16. A drive tool as claimed in claim 15 characterized in that the rounded design is elliptical.

17. A drive tool as claimed in claim 15 characterized in that the curvature of the rounded section of the entraining element is smaller than the curvature of the corresponding transition area on the drive of a screw, which has a B dimension that corresponds to the tool.

18. A drive system comprising a screw with a screw head having a drive, wherein the drive comprises cams formed by recesses introduced in the screw head around the cams, wherein each cam has two side faces which are used to transmit torque, and an end face connecting the side faces, said end face having a concave surface contour on the end of the screw head facing away from the screw shank characterized in that the end face is designed such that a virtual circular periphery around the screw axis in a plane perpendicular to the screw axis and having a radius associated with the plane has a point of contact on the cam with the end face, wherein—over at least one portion of the axial height of the end face—the contact region—a plurality of such points of contact are formed, said points of contact forming a contact line in the centre of the end face, and
a drive tool comprising a basic body which has integral entraining elements formed thereon in a radial extension from the basic body to the outside characterized in that the basic body, at least in an engaging region thereof, in which the tip for driving the screw is introduced into the screw, forms a conical portion which tapers toward the tip.
